(19) United States
(12) Patent Application Publication
(10) Pub. No.: US 2015/0239176 A1
(43) Pub. Date: Aug. 27, 2015

(54) THREE-DIMENSIONAL PRINTER WITH COLORING FUNCTION

(71) Applicant: Primax Electronics Ltd., Taipei (TW)

(72) Inventors: Yung-Hsien Ho, Taipei (TW); Hung-Wei Chiu, Taipei (TW); Chun-Hao Lo, Taipei (TW)

(21) Appl. No.: 14/316,430

(22) Filed: Jun. 26, 2014

(30) Foreign Application Priority Data
Feb. 21, 2014 (TW) 103105863

(51) Int. Cl. B29C 67/00

(52) U.S. Cl. CPC B29C 67/0088; B33Y 30/00

(57) ABSTRACT

A three-dimensional printer with a coloring function is provided. The three-dimensional printer includes a data unit, a three-dimensional object constructing unit, a coloring unit, and a controlling unit. The data unit has plural layered model data that are divided from a three-dimensional model data and has a color data corresponding to the three-dimensional model data. The three-dimensional object constructing unit includes a material nozzle. The coloring unit includes a lateral surface coloring nozzle. Under control of the controlling unit, plural construction materials are outputted downwardly through the material nozzle according to the plural layered model data sequentially, so that plural layered models are generated and stacked as a three-dimensional model. Moreover, under control of the controlling unit, plural inks are outputted through the lateral surface coloring nozzle according to the color data in order to color plural lateral surfaces of the three-dimensional model.

### FIELD OF THE INVENTION

The present invention relates to a three-dimensional printer, and more particularly to a three-dimensional printer with a coloring function.

### BACKGROUND OF THE INVENTION

A three-dimensional (3D) printing technology is a rapid prototyping (RP) technology. Conventionally, the 3D printing technology was widely used to produce a three-dimensional model in mold fabrication, industrial design and other fields. With increasing development, the 3D printing technology is gradually applied to the direct fabrication of various products or even used to fabricate some high-valued products such as hip joints, teeth or airplane parts. FIG. 1 is a schematic view illustrating the structure of a conventional three-dimensional printer. According to a three-dimensional model data, the three-dimensional printer 1 outputs plural construction materials M (e.g. powdery binding materials) downwardly through a material nozzle 11. Consequently, the plural construction materials M are gradually stacked as a three-dimensional object 9 on a layer-by-layer basis.

As known, the conventional three-dimensional printer is only able to fabricate the product with the color of the construction materials. For fabricating the aesthetically-pleasing product, it is feasible to impart a variety of colors to the product. Recently, two types of three-dimensional printers with a coloring function have been disclosed. In the first type three-dimensional printer, the construction materials with different colors are timely changed during the layer-by-layer process of stacking the construction materials, so that the finished product bears many kinds of colors. However, the method of operating this three-dimensional printer is not only time-consuming but also labor-intensive. In the second type three-dimensional printer, the construction materials with three primary colors (i.e. the red construction material, the green construction material and the blue construction material) are provided, and these construction materials are properly mixed to result in the construction materials with desired colors. However, the current color-mixing technology still has some drawbacks. For example, the mixed colors are very dull and inflexible and fail to meet the requirements of many people. Moreover, regardless of which of the above three-dimensional printers, the construction materials with colors may largely increase the fabricating cost. In other words, the conventional three-dimensional printers with the coloring function are not cost-effective.

For solving the above drawbacks, a three-dimensional printer with a coloring function has been disclosed in PCT Publication No. WO2012058278. FIG. 2 is a schematic view illustrating the structure of a three-dimensional printer disclosed in PCT Publication No. WO2012058278. As shown in FIG. 2, the three-dimensional printer 2 comprises a material nozzle 21 and a coloring nozzle 22. During a layer-by-layer process of stacking the construction materials M, the ink I with a color is timely and downwardly outputted from the coloring nozzle 22 according to the practical requirements. Consequently, the desired color is attached on the construction materials M.

However, the method of operating this three-dimensional printer still has some drawbacks. For example, if no ink is attached on the construction materials, the construction materials (e.g. powdery particles) may be connected with each other through strong physical interaction. In case that the three-dimensional printer is used to attach the ink I on the construction materials between layers, the construction materials are separated by the ink I. Under this circumstance, the structural strength of the three-dimensional object is deteriorated.

From the above discussions, the conventional three-dimensional printer needs to be further improved.

### SUMMARY OF THE INVENTION

An object of the present invention provides a three-dimensional printer for only coloring the lateral surfaces of the three-dimensional model under construction. Consequently, the structural strength of the three-dimensional model is not adversely affected.

In accordance with an aspect of the present invention, there is provided a three-dimensional printer with a coloring function. The three-dimensional printer includes a data unit, a three-dimensional object constructing unit, a coloring unit, and a controlling unit. The data unit has plural layered model data that are divided from a three-dimensional model data and has a color data corresponding to the three-dimensional model data. The three-dimensional object constructing unit includes a material nozzle. The coloring unit includes at least one lateral surface coloring nozzle. The controlling unit is connected with the data unit, the three-dimensional object constructing unit and the coloring unit. The three-dimensional object constructing unit is controlled by the controlling unit to output plural construction materials downwardly through the material nozzle according to the plural layered model data sequentially, so that plural layered models are generated and stacked as a three-dimensional model. According to the color data, the coloring unit is controlled by the controlling unit to output plural inks to color a lateral surface of the three-dimensional model under construction through the at least one lateral surface coloring nozzle.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating the structure of a conventional three-dimensional printer;

FIG. 2 is a schematic view illustrating the structure of a three-dimensional printer disclosed in PCT Publication No. WO2012058278;

FIG. 3 is a schematic functional block diagram illustrating a three-dimensional printer with a coloring function according to a first embodiment of the present invention;

FIG. 4 is a schematic front view illustrating the three-dimensional printer of FIG. 3;

FIG. 5 is a schematic side view illustrating the three-dimensional printer of FIG. 3;

FIG. 6 schematically illustrates the three-dimensional model that is completely constructed and placed on the constructing platform; and

FIG. 7 is a schematic front view illustrating a three-dimensional printer according to a second embodiment of the present invention.

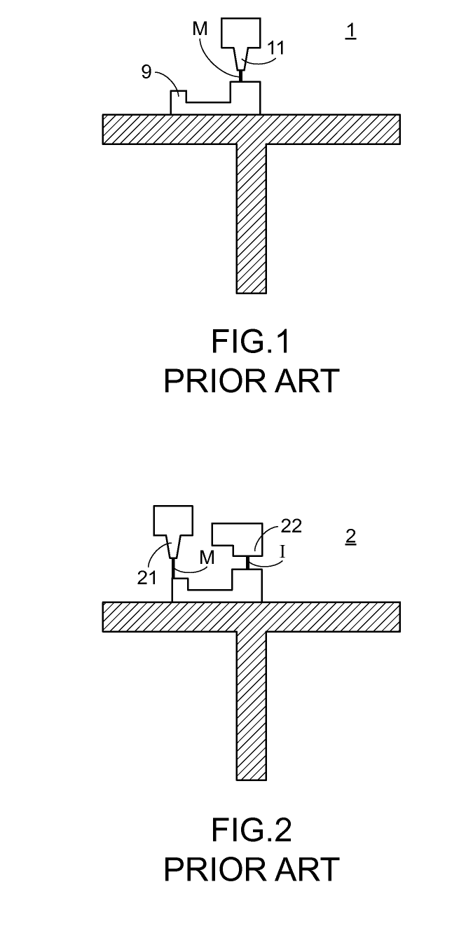

### DETAILED DESCRIPTION OF THE PREFERRED EMBODIMENT

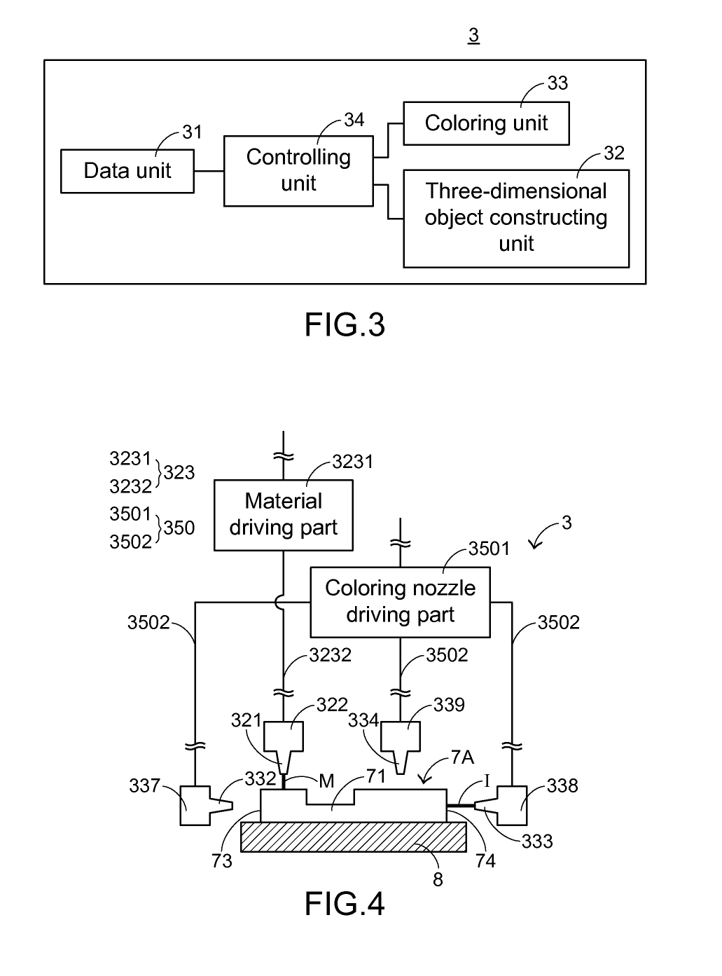

FIG. 3 is a schematic functional block diagram illustrating a three-dimensional printer with a coloring function according to a first embodiment of the present invention. As shown in FIG. 3, the three-dimensional printer 3 comprises a data unit 31, a three-dimensional object constructing unit 32, a coloring unit 33, and a controlling unit 34. The controlling unit 34 is connected with the data unit 31, the three-dimensional object constructing unit 32 and the coloring unit 33. The data unit 31 has plural layered model data that are divided from a three-dimensional model data and also has a color data corresponding to the three-dimensional model data. In this embodiment, the three-dimensional model data is an electronic data file about an entire structure of a three-dimensional model (i.e. an object to be constructed by the three-dimensional printer 3). The color data is an electronic data file about the exterior colors of the three-dimensional model.

In this embodiment, the three-dimensional model data and the color data may be provided by an external device (not shown), which is connected with the three-dimensional printer 3. For example, the external device is a computer or a USB device. After the three-dimensional model data is received, the three-dimensional model data is analyzed by the data unit 31, so that the three-dimensional model data is divided into the plural layered model data. The way of generating the plural layered model data is not restricted. For example, in some other embodiments, the plural layered model data may be generated by an external device and then transmitted to the data unit 31.

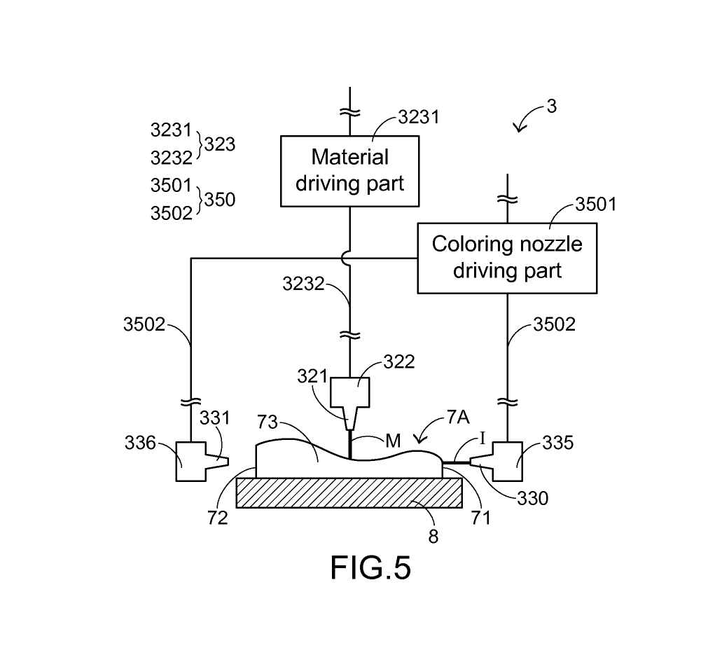

Please refer to FIGS. 4 and 5. FIG. 4 is a schematic front view illustrating the three-dimensional printer of FIG. 3. FIG. 5 is a schematic side view illustrating the three-dimensional printer of FIG. 3. The operations of the three-dimensional printer 3 are also shown in FIGS. 4 and 5. A three-dimensional model 7A under construction is placed on a constructing platform 8. The three-dimensional model 7A comprises a front surface 71, a rear surface lateral surface 72, a left surface 73, and a right surface 74.

Moreover, the three-dimensional object constructing unit 32 further comprises a material nozzle 321, a material storage device 322, and a material transmission mechanism 323. The material storage device 322 is used for storing plural construction materials M. In addition, the material storage device 322 is connected with the material nozzle 321. The material transmission mechanism 323 comprises a material driving part 3231 and a material transmission part 3232. For example, the material driving part 3231 is a motor for providing motive power to the material transmission part 3232, thereby driving the material transmission part 3232 to move the material nozzle 321 in a three-dimensional space along an upward direction, a downward direction, a frontward direction, a rearward direction, a leftward direction and a rightward direction.

Moreover, the coloring unit 33 comprises a front surface coloring nozzle 330, a rear surface coloring nozzle 331, a left surface coloring nozzle 332, a right surface coloring nozzle 333, a top surface coloring nozzle 334, a front ink storage device 335, a rear ink storage device 336, a left ink storage device 337, a right ink storage device 338, a top ink storage device 339, and a coloring transmission mechanism 350. The front ink storage device 335 is used for storing plural inks I. In addition, the front ink storage device 335 is in communication with the front surface coloring nozzle 330. The rear ink storage device 336 is used for storing plural inks I. In addition, the rear ink storage device 336 is in communication with the rear surface coloring nozzle 331. The left ink storage device 337 is used for storing plural inks I. In addition, the left ink storage device 337 is in communication with the left surface coloring nozzle 332. The right ink storage device 338 is used for storing plural inks I. In addition, the right ink storage device 338 is in communication with the right surface coloring nozzle 333. The top ink storage device 339 is used for storing plural inks I. In addition, the top ink storage device 339 in communication with the top surface coloring nozzle 334. The coloring transmission mechanism 350 comprises a coloring nozzle driving part 3501 and a coloring transmission part 3502. For example, the coloring nozzle driving part 3501 is a motor for providing motive power to the coloring transmission part 3502, thereby driving the coloring transmission part 3502 to move the front surface coloring nozzle 330, the rear surface coloring nozzle 331, the left surface coloring nozzle 332, the right surface coloring nozzle 333 and the top surface coloring nozzle 334 in a three-dimensional space along the upward direction, the downward direction, the frontward direction, the rearward direction, the leftward direction and the rightward direction individually or simultaneously.

For clarification and brevity, the left surface coloring nozzle 332, the right surface coloring nozzle 333 and a portion of the coloring transmission mechanism 350 are not shown in FIG. 5, and the front surface coloring nozzle 330, the rear surface coloring nozzle 331 and a portion of the coloring transmission mechanism 350 are not shown in FIG. 4.

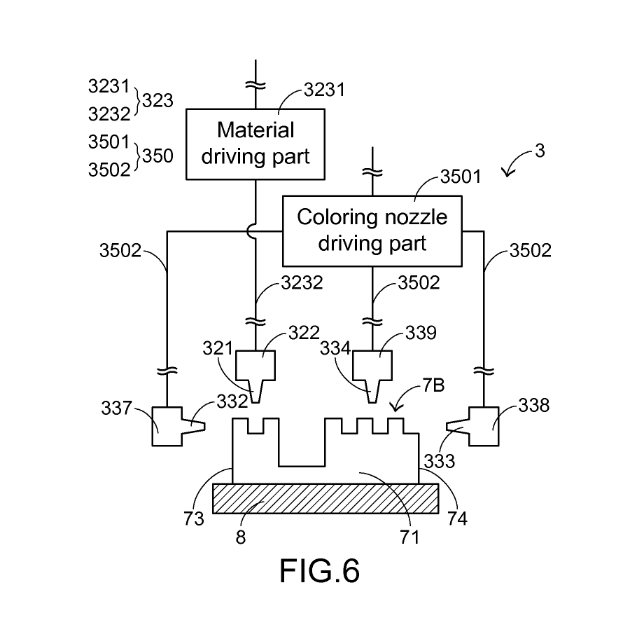

Hereinafter, the operations of the three-dimensional printer of the present invention will be illustrated with reference to FIGS. 4-6. FIG. 6 schematically illustrates the three-dimensional model 7B that is completely constructed and placed on the constructing platform. For clarification and brevity, the front surface coloring nozzle 330, the rear surface coloring nozzle 331 and a portion of the coloring transmission mechanism 350 are not shown in FIG. 6.

After the three-dimensional printer 3 is enabled, according to the plural layered model data of the data unit 31, the material nozzle 321 is controlled by the controlling unit 34 to be moved to corresponding blanking positions sequentially and the plural construction materials M are outputted downwardly from the material nozzle 321. Consequently, plural layered models corresponding to respective layered model data are generated. The generated layered models are stacked and attached on each other on a layer-by-layer basis until the entire of the three-dimensional model 7B is constructed.

During the layer-by-layer process of stacking and attaching the plural layered models, the following procedures are controlled by the controlling unit 34 according to the color data of the data unit 31. After the front surface coloring nozzle 330 is moved to the corresponding coloring position, the front surface coloring nozzle 330 ejects the plural inks I to color the front surface 71 of the three-dimensional model 7A under construction. After the rear surface coloring nozzle 331 is moved to the corresponding coloring position, the rear surface coloring nozzle 331 ejects the plural inks I to color the rear surface lateral surface 72 of the three-dimensional model 7A under construction. After the left surface coloring nozzle 332 is moved to the corresponding coloring position, the left surface coloring nozzle 332 ejects the plural inks I to color the left surface 73 of the three-dimensional model 7A under construction. After the right surface coloring nozzle 333 is moved to the corresponding coloring position, the right surface coloring nozzle 333 ejects the plural inks I to color the right surface 74 of the three-dimensional model 7A under construction. After the layer-by-layer process of stacking and attaching the plural layered models is competed, according to the color data, the controlling unit 34 will move the top surface coloring nozzle 334 to the corresponding coloring position and then eject the plural inks I downwardly to color a top surface 75 of the three-dimensional model 7B.

From the above descriptions, the present invention provides a three-dimensional printer. During the formation of the three-dimensional model of the three-dimensional printer, the coloring unit only colors the lateral surfaces of the three-dimensional model. Since no ink is attached on the construction materials, the physical interaction between adjacent layers of construction materials will not be separated by the inks thereon. Under this circumstance, the three-dimensional model is colorful and has strong structural strength. In other words, the three-dimensional printer of the present invention has industrial values.

However, those skilled in the art will readily observe that numerous modifications and alterations may be made while retaining the teachings of the invention. For example, in some other embodiments, the front ink storage device 335, the rear ink storage device 336, the left ink storage device 337, the right ink storage device 338 and the top ink storage device 339 are integrated into a shared right ink storage device.

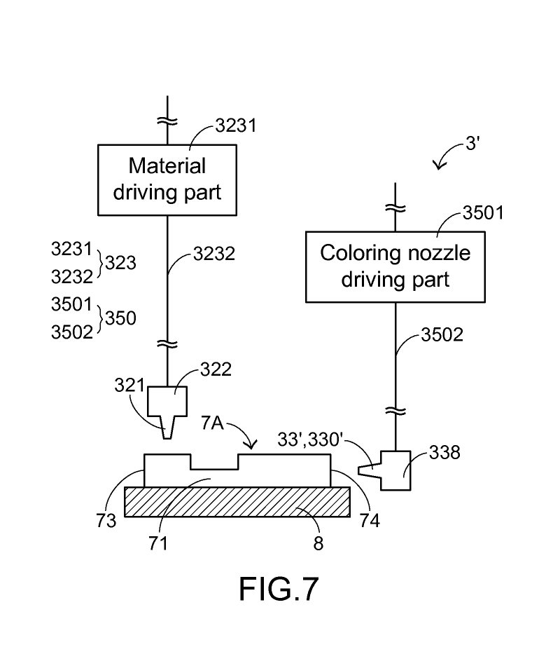

FIG. 7 is a schematic front view illustrating a three-dimensional printer according to a second embodiment of the present invention. In comparison with the three-dimensional printer 3 of the first embodiment, the coloring unit 33′ of the three-dimensional printer 3′ of this embodiment only has a single lateral surface coloring nozzle 330′. Moreover, during the layer-by-layer process of stacking and attaching the plural layered models, the following procedures are controlled by the controlling unit 34 according to the color data. That is, after the single lateral surface coloring nozzle 330′ is moved to a position near the corresponding lateral surface of the three-dimensional model 7A, the single lateral surface coloring nozzle 330′ is moved to the corresponding coloring position to eject the plural inks I to color the corresponding lateral surface of the three-dimensional model 7A.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A three-dimensional printer with a coloring function, the three-dimensional printer comprising:
a data unit having plural layered model data that are divided from a three-dimensional model data and having a color data corresponding to the three-dimensional model data;
a three-dimensional object constructing unit comprising a material nozzle;
a coloring unit comprising at least one lateral surface coloring nozzle; and
a controlling unit connected with the data unit, the three-dimensional object constructing unit and the coloring unit, wherein the three-dimensional object constructing unit is controlled by the controlling unit to output plural construction materials downwardly through the material nozzle according to the plural layered model data sequentially, so that plural layered models are generated and stacked as a three-dimensional model, wherein according to the color data, the coloring unit is controlled by the controlling unit to output plural inks to color a lateral surface of the three-dimensional model under construction through the at least one lateral surface coloring nozzle.

2. The three-dimensional printer according to claim 1, wherein the three-dimensional object constructing unit further comprises a material storage device, wherein the plural construction materials are stored in the material storage device, and the plural construction materials are outputted downwardly from the material nozzle.

3. The three-dimensional printer according to claim 1, wherein the coloring unit further comprises an ink storage device, wherein the plural inks are stored in the ink storage device, and the plural inks are outputted externally from the at least one lateral surface coloring nozzle.

4. The three-dimensional printer according to claim 1, wherein the at least one lateral surface coloring nozzle comprises plural lateral surface coloring nozzles, wherein the plural lateral surface coloring nozzles are arranged around the three-dimensional model under construction.

5. The three-dimensional printer according to claim 4, wherein the coloring unit further comprises a coloring transmission mechanism, wherein the coloring transmission mechanism is controlled by the controlling unit to drive movement of the plural lateral surface coloring nozzles to positions around the three-dimensional model under construction.

6. The three-dimensional printer according to claim 4, wherein the coloring unit further comprises a top surface coloring nozzle, wherein according to the color data, the coloring unit is controlled by the controlling unit to output plural inks downwardly to color a top surface of the three-dimensional model under construction through the top surface coloring nozzle.

7. The three-dimensional printer according to claim 1, wherein the coloring unit further comprises a coloring transmission mechanism, and the at least one lateral surface coloring nozzle comprises a single lateral surface coloring nozzle, wherein according to the color data, the coloring transmission mechanism is controlled by the controlling unit to drive movement of the single lateral surface coloring nozzle to a coloring position so as to color the three-dimensional model under construction.

8. The three-dimensional printer according to claim 7, wherein the coloring unit further comprises a top surface coloring nozzle, wherein according to the color data, the coloring unit is controlled by the controlling unit to output plural inks downwardly to color a top surface of the three-dimensional model under construction through the top surface coloring nozzle.
